(19) United States
(12) Patent Application Publication
(10) Pub. No.: US 2007/0041606 A1
(43) Pub. Date: Feb. 22, 2007

(54) Apparatus and method for noise cancellation in communication headset using dual-coil speaker

(75) Inventor: Allan E. Sheppard JR., Holden, MA (US)

Correspondence Address: MILLS & ONELLO LLP, ELEVEN BEACON STREET, SUITE 605, BOSTON, MA, 02108, US

(73) Assignee: David Clark Company Incorporated

(21) Appl. No.: 11/208,975

(22) Filed: Aug. 22, 2005

(51) Int. Cl. H04R 9/06

(52) U.S. Cl. 381/401

(57) ABSTRACT

A communication headset is disclosed that includes a speaker assembly. The speaker assembly includes at least a first speaker coil and a second speaker coil. One speaker coil is for receiving a communication signal, and another speaker coil is for receiving an active noise cancellation signal. Each of the speaker coils co-acts with a magnetic field for causing a diaphragm to move responsive to the communication signal and the active noise cancellation signal individually or simultaneously.

### BACKGROUND OF THE INVENTION

1. Field of the Invention

The invention relates generally to communication headsets, and relates in particular to communication headsets that provide active noise cancellation.

2. Description of the Related Art

Communication headsets typically include a speaker assembly in one or both earpieces of a headset. The earpieces may include, for example, ear domes that surround an ear and are urged against a user's head, ear pads that contact and are urged against the outer helix of a user's ear, or earplugs that engage the inner helix or canal of a user's ear.

Communication headsets that provide active noise cancellation typically include a microphone assembly in one or both earpieces that converts ambient noise to electrical signals and provides those electrical signals to an electronic circuit in an effort to cancel the background signal from the environment. For example, U.S. Pat. No. 4,455,675 discloses a headset system that includes active noise cancellation in which signals received by a microphone are inverted and amplified, and are then electrically combined with a communication signal prior to being sent to the speaker. In certain situations, however, such systems may cancel a portion of the communication signal itself or may not effectively remove noise as a result of mixing the communication signal with the cancellation signal by an electronic means.

Other prior art systems may direct inverted and amplified feedback signals to a second speaker within an earpiece. In such systems, the acoustic signal output by the second speaker is used to acoustically cancel noise from the environment. A drawback to such multiple-speaker headsets is that they may be larger and heavier than single-speaker headsets, and may be relatively more expensive to produce.

### SUMMARY OF THE INVENTION

The present invention is directed to a device for canceling noise in a speaker. The device includes first and second speaker coils. The first speaker coil receives a communication signal, and the second speaker coil receives an active noise cancellation signal. Each of the first and second speaker coils co-acts with a magnetic field causing a diaphragm to move responsive to each of the applied signals.

In one embodiment, the first and second speaker coils are concentrically wound. In another embodiment, the first and second speaker coils are helically wound. Further, in another embodiment, the first and second speaker coils are wound in layers.

In one embodiment, the device for canceling noise includes a microphone that provides signals to be used to cancel-noise. The microphone provides a background signal to a feedback network. The active noise cancellation signal is produced responsive to the background signal.

In one embodiment, the feedback network includes a communication equalizer for preconditioning an input signal. The feedback network can further include a digital signal processor. The digital signal processor can include a digitally created analog output signal, a pulse width modulated output signal, or a pulse width and frequency modulated output signal.

In another embodiment, the device for canceling noise further includes a low impedance passive network. The low impedance passive network equalizes the communication signal before the communication signal is applied to the first speaker coil.

In one embodiment, the magnetic field extends radially outward from a magnet through the first and second speaker coils and then returns to the magnet through a magnetic structure. The magnetic structure can include the magnet, a cup shaped structure, and a plate. The magnet is positioned between the cup shaped structure and the plate. The first and second speaker coils can be positioned to pass through an annular opening in the magnetic structure.

In accordance with another aspect of the invention, the invention is directed to a speaker with noise cancellation. The speaker includes first and second speaker coils and a magnet. The first speaker coil receives a communication signal and is coupled to a diaphragm. The second speaker coil receives an active noise cancellation signal and is also coupled to the diaphragm. The magnet is positioned such that a magnetic field extends through the first and second speaker coils.

In one embodiment, the first and second speaker coils are concentrically wound. In another embodiment, the first and second speaker coils are helically wound. Further, in another embodiment the first and second speaker coils are wound in layers.

In one embodiment, the speaker includes a microphone. The microphone provides a background signal to a feedback network. The active noise cancellation signal is produced in response to the background signal. The feedback network can include a loop equalizer that filters and amplifies the background signal. The feedback network can include a communication equalizer that preconditions an input signal. The feedback network can include a digital signal processor. The digital signal processor can include a digitally created analog signal, a pulse width modulated output signal, or a pulse width and frequency modulated output signal.

In one embodiment, the speaker further includes a low impedance passive network that equalizes the communication signal before the communication signal is applied to the first speaker coil.

In one embodiment, the magnetic field extends radially outward from the magnet through the first and second speaker coils and then returns to the magnet through a magnetic structure. The magnetic structure can include the magnet, a cup shaped structure, and a plate. The magnet is positioned between the cup shaped structure and the plate. The first and second speaker coils can be positioned to pass through an annular opening in the magnetic structure.

In one embodiment, the diaphragm is coupled to an outer shell and includes folds in the diaphragm. The folds in the diaphragm facilitate protrusion and retraction of the diaphragm with respect to the outer shell.

In one embodiment, the diaphragm includes a center and an annular diaphragm. Alternatively, the diaphragm can include a single unitary diaphragm.

In one embodiment, the first and second speaker coils co-acting with the magnetic field cause the diaphragm to move responsive to both the communication signal and the active noise cancellation signal.

In one embodiment, the speaker includes a microphone. The microphone provides background noise to a feedforward network. The active noise cancellation signal is produced in response to the background signal.

In one embodiment, the speaker is a headset speaker.

In accordance with another aspect of the invention, the invention is directed to a communication headset including a speaker assembly. The speaker assembly includes first and second speaker coils. The first speaker coil receives a communication signal. The second speaker coil receives an active noise cancellation signal. Each of the first and second speaker coils co-acts with a magnetic field causing a diaphragm to move responsive to each of the applied signals.

In one embodiment, the first and second speaker coils are concentrically wound. In another embodiment, the first and second speaker coils are helically wound. Further, in another embodiment, the first and second speaker coils are wound in layers.

In one embodiment, the speaker assembly further includes a microphone. The microphone provides a background signal to a feedback network. The active noise cancellation signal is produced in response to the background signal. The feedback network can include a communication equalizer that preconditions an input signal. The feedback network can include a digital signal processor. The digital signal processor can include a digitally created analog signal, a pulse width modulated output signal, or a pulse width and frequency modulated output signal.

In one embodiment, the speaker assembly further includes a low impedance passive network. The low impedance passive network equalizes the communication signal before the communication signal is applied to the first speaker coil.

In one embodiment, the magnetic field extends radially outward from the magnet through the first and second speaker coils and then returns to the magnet through a magnetic structure. The magnetic structure can include the magnet, a cup shaped structure, and a plate. The magnet is positioned between the cup shaped structure and the plate. The first and second speaker coils can be positioned to pass through an annular opening in the magnetic structure.

### BRIEF DESCRIPTION OF THE DRAWINGS

The foregoing and other objects, features and advantages of the invention will be apparent from the more particular description of preferred aspects of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic diagram of a dual coil speaker system in accordance with an embodiment of the invention.

FIG. 2 contains a detailed schematic functional block diagram of a system in accordance with an embodiment of the invention.

FIG. 3 contains a schematic diagram of a dual coil speaker for use in a communication headset in accordance with an embodiment of the invention.

FIG. 4 contains a schematic cross-sectional view of the dual coil speaker shown in FIG. 3 taken along line 4-4 of FIG. 3.

FIG. 5 contains a schematic diagram of a microphone mounting structure for use with a dual coil speaker in accordance with an embodiment of the invention.

FIG. 6 contains a schematic cross-sectional diagram of the dual coil speaker of FIG. 3 and the microphone mounting structure of FIG. 5 taken along line 4-4 of FIG. 3.

FIG. 7 contains a schematic block diagram of a communication equalizer of FIG. 2.

FIG. 8 contains a schematic block diagram of a loop equalizer of FIG. 2.

FIG. 9 is a schematic cross-sectional view of a magnetic structure of FIG. 4.

FIG. 10 is a schematic diagram of a communication headset including a dual coil speaker in accordance with an embodiment of the invention.

### DETAILED DESCRIPTION OF PREFERRED EMBODIMENTS OF THE INVENTION

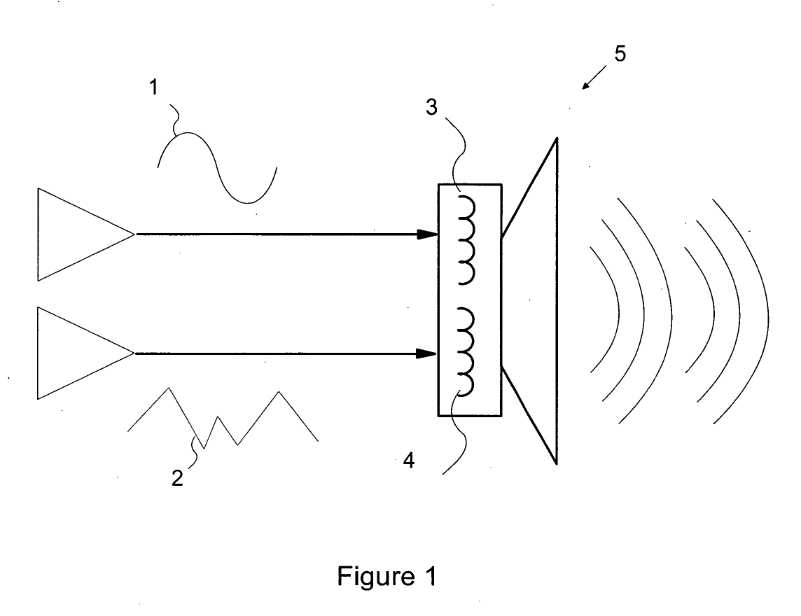

FIG. 1 is a schematic diagram of a dual-coil speaker system in accordance with an embodiment of the invention. As shown in FIG. 1, a speaker system 5 in accordance with an embodiment of the invention receives a communication, e.g., voice, signal 1 and a noise cancellation signal 2. The voice signal 1 is applied to a coil 3, and the noise cancellation signal is applied to a coil 4. The two coils coact to move the diaphragm of the speaker such that the speaker outputs a signal that is a combination, e.g., summation, of the communication, e.g., voice, signal 1 and the noise cancellation signal 2.

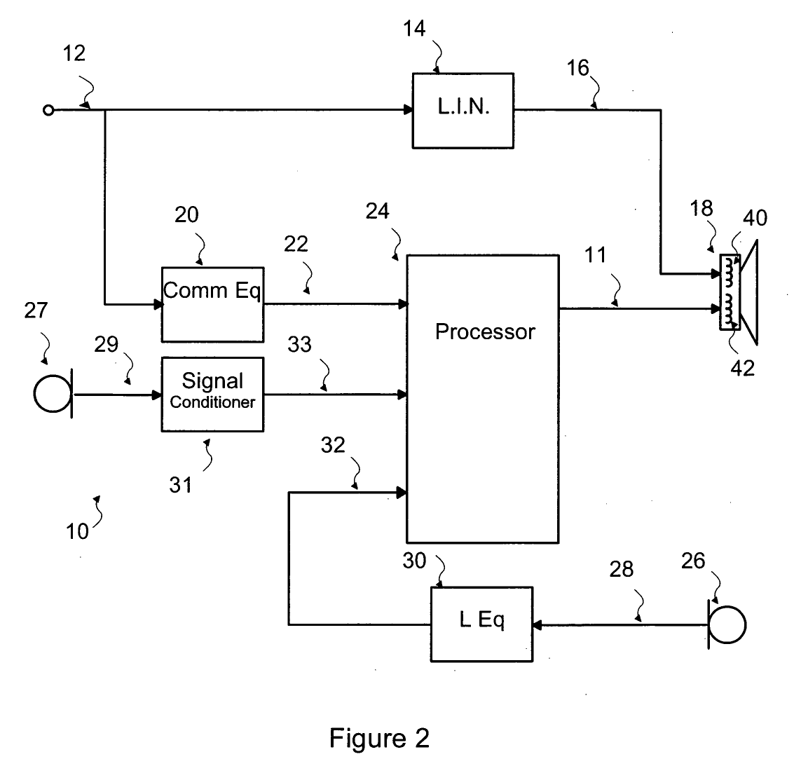

FIG. 2 is a detailed schematic functional block diagram of a system in accordance with an embodiment of the invention. As shown in FIG. 2, a system 10 in accordance with an embodiment of the invention receives an electrical input signal 12. The electrical input signal 12 is used in producing an acoustic output signal such as a voice, music or other such signal for applications such as communications, entertainment, etc., via a headset, for example, a headset 6 of FIG. 10, or other such device that uses a speaker to produce the acoustic output signal. The system 10 of FIG. 2 is included in one or both of ear pieces 7 of the headset 6 of FIG. 10. The input electrical signal 12 is optionally applied to a low impedance passive network 14, and the output signal 16 of the low impedance passive network 14 is provided to a first coil, e.g., a voice coil, 40 of a speaker assembly 18. The low impedance passive network equalizes the input electrical signal 12 to create a flat acoustical response in active and passive modes. The voice coil 40 is excited by the signal 16, causing motion in the diaphragm of the speaker assembly 18.

The electrical input signal 12 (or 16) is also provided to a communication equalizer circuit 20, and the output signal 22 from the communication equalizer is provided to a processor 24. The communication equalizer preconditions the electrical input signal 12 (or 16), so that when the processor 24 attempts to remove the electrical input signal, it removes the conditioning.

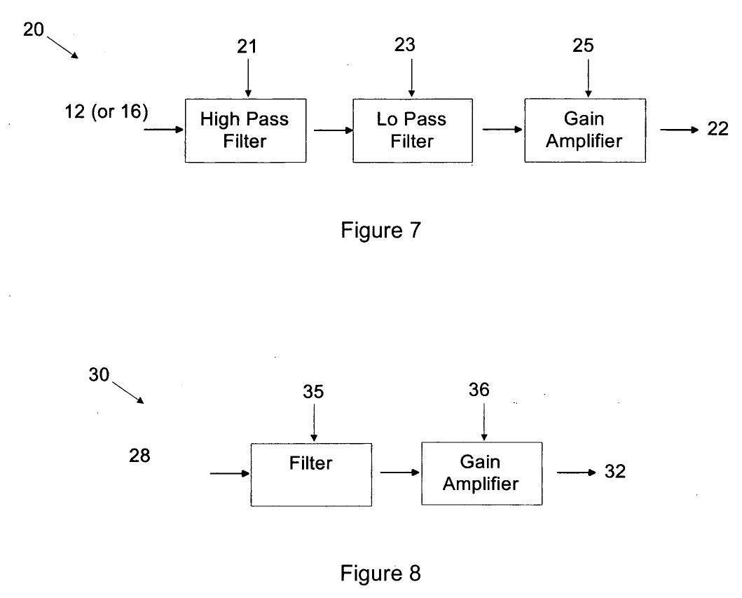

FIG. 7 is a detailed schematic block diagram of the communication equalizer of FIG. 2. In one embodiment of the communication equalizer of FIG. 7, the electrical input signal 12 (or 16) is input to a high pass filter 21. A high pass filtered output of the high pass filter 21 is input to a low pass filter 23. The output of the low pass filter 23 is input to a gain amplifier 25, and the gain amplifier 25 outputs the output signal 22. This configuration of the high pass filter 21, low pass filter 23 and gain amplifier 25 creates a boost in the signal, such that when the boost is summed with a loss of the signal due to an anisotropic magnetoresistance (AMR) effect, the signal is equalized. The output signal 22 is as flat as the signal was when the power was turned on.

Referring again to FIG. 2, the processor 24 processes signals 22, 33 and 32 to produce a noise cancellation signal 11, which is applied to a second coil, e.g., a noise cancellation coil, 42 of the speaker assembly 18. A microphone assembly 26 converts background noise from the environment near the speaker assembly 18, and, therefore, near the user's ear, to an electrical signal 28, which is applied to a loop equalizer 30. microphone assembly 26 may provide signals that represent noise internal or external to the headset.

FIG. 8 is a detailed schematic block diagram of the loop equalizer of FIG. 2. The loop equalizer 30 of FIG. 8 includes a filter 35 and an amplifier 36. The loop equalizer 30 receives the passive response of the ear cup, and makes the system stable by preventing oscillation, while providing amplification to provide a stable operation control loop.

Referring again to FIG. 2, the output signal 32 from the loop equalizer 30 is provided to the processor 24. An optional second microphone 27 may also be used to convert external noise to another electrical signal 29 used in feed forward active noise cancellation, which is then applied to a signal conditioner 31. The microphone 27 may provide signals that represent noise internal or external to the headset. The second microphone 27 is used in digital systems. The output signal 33 of the signal conditioner 31 is applied to the processor 24. The signal conditioner 31 provides filtering and amplification. The signal conditioner 31 filters the electrical signal 29, such that the signal is within a noise cancellation band.

During operation, a portion of the communication signal 12 (or 16) is supplied to the processor 24 via the communication equalizer circuit 20 to ensure that the sound that is produced by the speaker assembly 18 responsive to the communication signal itself is not cancelled. The use of two separate and independent coils 40 and 42 in the speaker assembly 18 of the invention permits the voice or communication signal 16 and the noise cancellation signal 11 to be supplied to the same speaker without requiring that the two signals be electrically combined prior to being delivered to a single speaker. Although the first coil 40 is described above as being the communication coil or voice coil and the second coil 42 is described as being the noise cancellation coil, either coil 40, 42 may receive either signal and may perform either function. This aspect of the invention provides a failsafe mode of operation, in that a failure of the processor 24 such as in not producing and delivering a noise cancellation signal, will not prevent the communication signal from being provided to the user of the speaker. It also allows either or both of the communication signal 16 and the noise cancellation signal to be purely analog, or to be an analog signal represented by a digital signal. The digital signal may be a pseudo-analog signal, as from a digital-to-analog converter, or a pulse width modulated, or a frequency and pulse width modulated signal, for example, in a class D amplifier in which a digital signal is pulsed at a predetermined rate and duration. In the latter cases, the speaker would perform a mathematical integration, generating the signal represented by the modulation of the aforementioned digital signals.

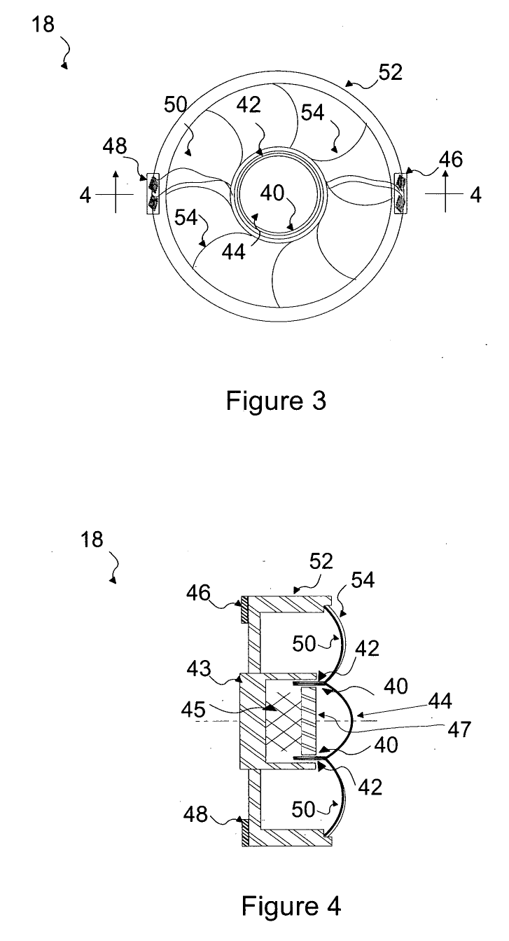

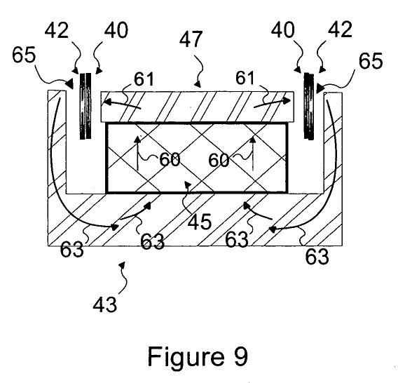

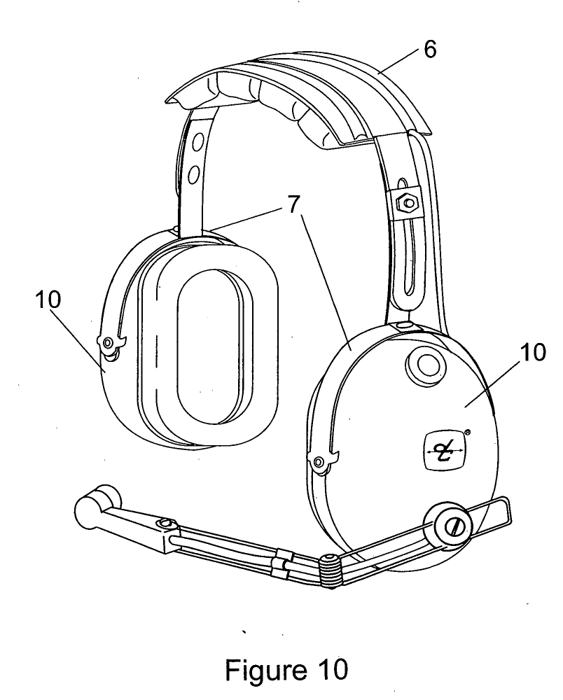

FIG. 3 contains a schematic diagram of a dual coil speaker for use in a communication headset in accordance with an embodiment of the invention, and FIG. 4 is a cross-sectional view of the dual coil speaker shown in FIG. 3 taken along line 4-4 of FIG. 3. As shown in FIGS. 3 and 4, the two coils 40, 42 in the speaker assembly 18 are concentrically wound in a cylindrical shape and are attached at a first cylindrical end to a diaphragm. The diaphragm preferably includes folds 54. It will be understood that other coil configurations may be used in accordance with the present invention. For example, the coils 40 and 42 may be wound in other geometric shapes such as spirals or helical, and may be individually wound in layers, or with multiple strand wire, with certain strands allotted to certain coils. Conductive ends of the speaker coils 40, 42 are electrically connected to ports 46 and 48, as described in detail below in connection with FIG. 9. The diaphragm may include an annular diaphragm 50 and/or a center diaphragm 44 that are both attached to the two speaker coils as shown in FIG. 4. The annular diaphragm 50 is also attached to an outer shell 52 at the outer peripheral edge of the diaphragm 50. The diaphragm 50 preferably includes folds 54. It will be understood that other diaphragm configurations may be used in accordance with the present invention. For example, the diaphragm may be comprised of a single unitary diaphragm that is attached to the two speaker coils on one side of the diaphragm.

FIG. 9 is a schematic cross-sectional view of the magnetic structure of FIG. 2. As shown in FIGS. 4 and 9, the second cylindrical end of each speaker coil 40, 42 is positioned to pass through an annular opening 65 in a magnetic structure that includes a cup shaped structure 43, a magnet 45, and a top plate 47. The opening 65 is formed between the edges of the top plate 47 and the cup shaped structure 43. The magnet 45 is positioned within the cup shaped structure 43 such that magnetic lines of flux pass from the top of the magnet 45 (arrows 60) radially outward from the top plate 47 (arrows 61) through the two speaker coils 40, 42, around the outer wall of the cup shaped structure 43 (arrows 63) and return to the magnet 45 at the bottom thereof. As shown in FIG. 3, conductive ends of the speaker coils 40, 42 are electrically connected to ports 46 and 48, respectively, for providing two independent driving currents to the speaker.

When either or both coils 40, 42 receive a signal, the coils 40, 42 move with respect to the cup shaped structure 43, magnet 45 and top plate 47, and specifically move in and out of the enclosure formed by the structure 43 and the top plate 47. As the coils 40 and 42 move, the diaphragm 50 and center diaphragm 44 move, thus producing sound. Each of the coils 40 and 42 may, therefore, separately or simultaneously drive the speaker 18. The diaphragm 50 preferably includes folds 54 that generally extend radially, providing greater flexibility of the diaphragm.

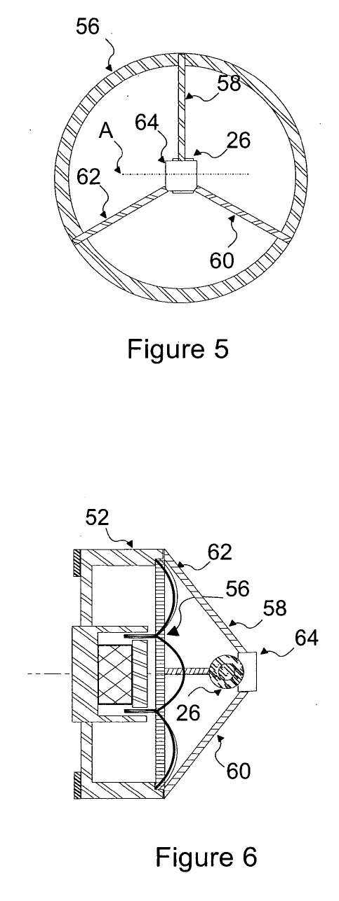

FIG. 5 contains a schematic diagram of a microphone mounting structure for use with a dual coil speaker in accordance with an embodiment of the invention, and FIG. 6 contains a schematic cross-sectional view of the dual coil speaker of FIG. 3 and the microphone mounting structure of FIG. 5 taken along line 4-4 of FIG. 3 As shown in FIG. 5 and FIG. 6, a subassembly of a communication headset in accordance with an embodiment of the invention may include a microphone mounting structure 56 that includes spokes 58, 60, 62 and a microphone mounting plate 64 onto which the microphone 26 may be mounted. The microphone 26 may be positioned near the center diaphragm 44 or close to the edge of the outer shell 52.

FIG. 10 is a schematic diagram of a communication headset 6 including the system 10 of FIG. 2 in accordance with an embodiment of the invention. The headset 6 includes the system 10 in one or both of ear pieces 7 of the headset 6 of FIG. 10.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A device for canceling noise, comprising:
a first speaker coil for receiving a communication signal;
a second speaker coil for receiving an active noise cancellation signal, each of the first and second speaker coils co-acting with a magnetic field for causing a diaphragm to move responsive to each of the communication signal and the active noise cancellation signal.

2. The device as claimed in claim 1, wherein the first and second speaker coils are concentric.

3. The device as claimed in claim 1, wherein the first and second speaker coils are helical.

4. The device as claimed in claim 1, wherein the first and second speaker coils are layered.

5. The device as claimed in claim 1, wherein the device for canceling noise further includes a microphone that provides a background signal to a feedback network, and the active noise cancellation signal is produced responsive to the background signal.

6. The device as claimed in claim 5, wherein the feedback network includes a communication equalizer for preconditioning an input signal.

7. The device as claimed in claim 1, further comprising a digital signal processor.

8. The device as claimed in claim 7, wherein the digital signal processor includes at least one of a digitally created analog output signal, a pulse width modulated output signal, and a pulse width and frequency modulated output signal.

9. The device as claimed in claim 1, wherein the device for canceling noise further includes a low impedance passive network for equalizing the communication signal before the communication signal is applied to the first speaker coil.

10. The device as claimed in claim 1, wherein the magnetic field extends radially outwardly from a magnet through the first and second speaker coils and returns to the magnet via a magnetic structure.

11. The device as claimed in claim 10, wherein the magnet structure includes the magnet, a cup shaped structure, and a plate, the magnet being positioned between the cup shaped structure and the plate.

12. The device as claimed in claim 10, wherein the first and second speaker coils are positioned to pass through an annular opening in the magnetic structure.

13. A speaker for noise cancellation, comprising:
a first speaker coil for receiving a communication signal, the first speaker coil being coupled to a diaphragm;
a second speaker coil for receiving an active noise cancellation signal, the second speaker coil being coupled to the diaphragm;
a magnet being positioned such that a magnetic field extends through the first and second speaker coils.

14. The speaker as claimed in claim 13, wherein the first and second speaker coils are concentric.

15. The speaker as claimed in claim 13, wherein the first and second speaker coils are helical.

16. The speaker as claimed in claim 13, wherein the first and second speaker coils are layered.

17. The speaker as claimed in claim 13, wherein the speaker is coupled to a microphone that provides a background signal to a feedback network, and the active noise cancellation signal is produced responsive to the background signal.

18. The speaker as claimed in claim 17, wherein the feedback network includes a loop equalizer for filtering and amplifying the background signal.

19. The speaker as claimed in claim 17, wherein the feedback network includes a communication equalizer for preconditioning an input signal.

20. The speaker as claimed in claim 17, wherein the feedback network includes a digital signal processor.

21. The speaker as claimed in claim 20, wherein the digital signal processor includes at least one of a digitally created analog output signal, a pulse width modulated output signal, and a pulse width and frequency modulated output signal.

22. The speaker as claimed in claim 13, wherein the speaker is coupled to a low impedance passive network for equalizing the communication signal before the communication signal is applied to the first speaker coil.

23. The speaker as claimed in claim 13, wherein the magnetic field extends radially outward from the magnet through the first and second speaker coils and returns to the magnet via a magnetic structure.

24. The speaker as claimed in claim 23, wherein the magnet structure includes the magnet, a cup shaped structure, and a plate, the magnet being positioned between the cup shaped structure and the plate.

25. The speaker as claimed in claim 23, wherein the first and second speaker coils are positioned to pass through an annular opening in the magnetic structure.

26. The speaker as claimed in claim 13, wherein the diaphragm is coupled to an outer shell and includes folds in the diaphragm to facilitate protrusion and retraction of the diaphragm with respect to the outer shell.

27. The speaker as claimed in claim 13, wherein the diaphragm comprises a center diaphragm and an annular diaphragm.

28. The speaker as claimed in claim 13, wherein the diaphragm comprises a single unitary diaphragm.

29. The speaker as claimed in claim 13, wherein first and second speaker coils acting with the magnetic field cause the diaphragm to move responsive to each of the communication signal and the active noise cancellation signal.

30. The speaker as claimed in claim 13, wherein the speaker is coupled to a microphone that provides a background signal to a feedforward network, and the active noise cancellation signal is produced responsive to the background signal.

31. The speaker as claimed in claim 13, wherein the speaker is a headset speaker.

32. A communication headset including a speaker assembly, said speaker assembly comprising:
a first speaker coil for receiving a communication signal; and
a second speaker coil for receiving an active noise cancellation signal, each of the first and second speaker coils co-acting with a magnetic field for causing a diaphragm to move responsive to each of the communication signal and the active noise cancellation signal.

33. The communication headset as claimed in claim 32, wherein the first and second speaker coils are concentric.

34. The communication headset as claimed in claim 32, wherein the first and second speaker coils are helical.

35. The communication headset as claimed in claim 32, wherein the first and second speaker coils are layered.

36. The communication headset as claimed in claim 32, wherein the speaker assembly is coupled to a microphone that provides a background signal to a feedback network, and the active noise cancellation signal is produced responsive to the background signal.

37. The communication headset as claimed in claim 36, wherein the feedback network includes a communication equalizer for preconditioning an input signal.

38. The communication headset as claimed in claim 36, wherein the feedback network includes a digital signal processor.

39. The communication headset as claimed in claim 38, wherein the digital signal processor includes at least one of a digitally created analog output signal, a pulse width modulated output signal, and a pulse width and frequency modulated output signal.

40. The communication headset as claimed in claim 32, wherein the speaker assembly is coupled to a low impedance passive network for equalizing the communication signal before the communication signal is applied to the first speaker coil.

41. The communication headset as claimed in claim 32, wherein the magnetic field extends radially outwardly from a magnet through the first and second speaker coils and returns to the magnet via a magnetic structure.

42. The communication headset as claimed in claim 41, wherein the magnet structure includes a magnet, a cup shaped structure, and a plate, the magnet being positioned between the cup shaped structure and the plate.

43. The communication headset as claimed in claim 41, wherein the first and second speaker coils are positioned to pass through an annular opening in the magnetic structure.
